(19) United States
(12) Patent Application Publication
(10) Pub. No.: US 2018/0247265 A1
(43) Pub. Date: Aug. 30, 2018

(54) TASK GROUPING METHOD AND APPARATUS, ELECTRONIC DEVICE, AND COMPUTER STORAGE MEDIUM

(71) Applicant: Beijing Xiaodu Information Technology Co., Ltd., Beijing (CN)

(72) Inventors: Shaojian Huang, Beijing (CN); Dairui Cui, Beijing (CN); Mingquan Xu, Beijing (CN); Lang Liu, Beijing (CN); Ke Xian, Beijing (CN); Jinqing Chen, Beijing (CN); Qiuyuan Yang, Beijing (CN); Bin Zhang, Beijing (CN)

(21) Appl. No.: 15/965,740

(22) Filed: Apr. 27, 2018

Related U.S. Application Data
(63) Continuation of application No. PCT/CN2017/094786, filed on Jul. 27, 2017.

(30) Foreign Application Priority Data
Nov. 25, 2016 (CN) 201611052191.1

(51) Int. Cl. G06Q 10/08

(52) U.S. Cl. CPC G06Q 10/08355

(57) ABSTRACT

Embodiments of the present invention provide a task grouping method and apparatus, an electronic device, and a computer storage medium. The method includes: obtaining a similarity threshold according to a processing resource load pressure in a task source, and grouping multiple to-be-processed tasks in the task source according to similarity between the multiple to-be-processed tasks and the similarity threshold, to obtain a grouping result. A similarity threshold used for obtaining task groups by grouping is obtained according to the current processing resource load pressure in the task source, i.e., the similarity threshold dynamically changes according to the processing resource load pressure. Therefore, the task grouping result can adapt to the processing resource load pressure, and this helps improve processing resource utilization and task processing efficiency.

### CROSS REFERENCE

This application claims priority to International Patent Application No. PCT/CN2017/0094786, filed on Jul. 27, 2017 and entitled “TASK GROUPING METHOD AND APPARATUS, ELECTRONIC DEVICE, AND COMPUTER STORAGE MEDIUM”, which claims priority to Chinese Patent Application No. 201611052191.1, filed with the Chinese Patent Office on Nov. 25, 2016 and entitled “TASK GROUPING METHOD AND APPARATUS”, all of which are incorporated herein by reference in their entirety.

### TECHNICAL FIELD

The present invention relates to the field of Internet technologies, and in particular, to a task grouping method and apparatus, an electronic device, and a computer storage medium.

### BACKGROUND

With the rapid development of Internet technologies, there are increasing numbers of Internet-based applications, such as take-out applications and shopping applications. Using these applications, a user can obtain the needed products without leaving his/her home. While they are convenient to users, these applications need to deal with the issue of product delivery. Thus, logistics dispatch systems have emerged accordingly. The main task of a logistics system is to allocate a new order to a suitable delivery person. The existing delivery order allocation process is as follows: To reduce the use of delivery resources, the logistics scheduling system groups multiple received delivery orders based on a similarity measurement result, and allocates the delivery orders in groups to a delivery person for delivery.

### SUMMARY

Embodiments of the present invention provide a task grouping method and apparatus, an electronic device, and a computer storage medium, so as to improve processing resource utilization and task processing efficiency.

An embodiment of the present invention provides a task grouping method, including:
obtaining a similarity threshold according to a processing resource load pressure in a task source; and
grouping multiple to-be-processed tasks in the task source according to similarity between the multiple to-be-processed tasks and the similarity threshold, to obtain a first grouping result.

Optionally, the method further includes:
adjusting the similarity threshold according to a threshold increment; and
grouping the multiple to-be-processed tasks according to the similarity and the adjusted similarity threshold, to obtain a second grouping result.

Optionally, the method further includes:
selecting one of the first grouping result and the second grouping result as a target grouping result; and
allocating a corresponding processing resource to a task group in the target grouping result.

Optionally, the step of selecting a target grouping result includes:
respectively pre-allocating processing resources to a task group in the first grouping result and a task group in the second grouping result;
simulating processing, by the processing resource, on the task group to which the processing resource is pre-allocated; and
selecting one of the first grouping result and the second grouping result as the target grouping result according to simulation results respectively corresponding to the first grouping result and the second grouping result.

An embodiment of the present invention provides a task grouping apparatus, including:
an obtaining module, configured to obtain a similarity threshold according to a processing resource load pressure in a task source; and
a first grouping module, configured to group multiple to-be-processed tasks in the task source according to similarity between the multiple to-be-processed tasks and the similarity threshold, to obtain a first grouping result.

An embodiment of the present invention provides a computer storage medium, where the computer storage medium stores a computer program, and when the computer program is executed, steps in the task grouping method are implemented.

An embodiment of the present invention provides an electronic device, including a memory and a processor, where
the memory is configured to store one or more computer instructions, and the one or more computer instructions are executed by the processor to implement the task grouping method.

According to the task grouping method and apparatus provided in the embodiments of the present invention, when multiple to-be-processed tasks in a task source need to be grouped, similarity between the multiple to-be-processed tasks is first calculated based on a similarity measurement parameter, then a corresponding similarity threshold is obtained according to current processing resource load pressure in the task source, and afterwards, the multiple to-be-processed tasks are grouped according to the result of comparing the similarity threshold with the similarity between the multiple to-be-processed tasks to obtain a corresponding grouping result, so as to allocate a corresponding processing resource to each task group based on the grouping result for task processing. The similarity threshold used for obtaining task groups by grouping is obtained according to the current processing resource load pressure in the task source, i.e., the similarity threshold dynamically changes according to the processing resource load pressure. Therefore, the task grouping result can adapt to the processing resource load pressure, which helps improve processing resource utilization and task processing efficiency.

### BRIEF DESCRIPTION OF DRAWINGS

To describe the technical solutions in the embodiments of the present invention or in the prior art more clearly, the following briefly describes the accompanying drawings required for describing the embodiments or the prior art.

Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a task grouping method according to an embodiment of the present invention;

FIG. 2 is a flowchart of Embodiment 2 of a task grouping method according to an embodiment of the present invention;

FIG. 3a is a flowchart of Embodiment 3 of a task grouping method according to an embodiment of the present invention;

FIG. 3b is a flowchart of an implementation of step 303 in the embodiment shown in FIG. 3a;

FIG. 4A and FIG. 4B are a flowchart of Embodiment 4 of a task grouping method according to an embodiment of the present invention;

FIG. 5 is a diagram of an implementation principle corresponding to the embodiment shown in FIG. 4A and FIG. 4B;

FIG. 6 is a schematic structural diagram of Embodiment 1 of a task grouping apparatus according to an embodiment of the present invention;

FIG. 7 is a schematic structural diagram of Embodiment 2 of a task grouping apparatus according to an embodiment of the present invention; and

FIG. 8 is a schematic structural diagram of Embodiment 3 of a task grouping apparatus according to an embodiment of the present invention.

### DESCRIPTION OF EMBODIMENTS

To make the objectives, technical solutions, and advantages of the embodiments of the present invention clearer, the technical solutions in the embodiments of the present invention are described with reference to the accompanying drawings in the embodiments of the present invention. The described embodiments are merely some rather than all of the embodiments of the present invention. All other embodiments obtained by persons of ordinary skill in the art based on the embodiments of the present invention without creative efforts shall fall within the protection scope of the present invention.

The terms used in the embodiments of the present invention are merely for the purpose of illustrating specific embodiments, and are not intended to limit the present invention. The terms “a”, “said”, and “the” of singular forms used in the embodiments and the appended claims of the present invention are also intended to include plural forms, unless otherwise specified in the context clearly. The term “multiple” generally includes “at least two”, but “at least one” is not excluded.

It should be understood that, the term “and/or” used in this specification describes only an association relationship for describing associated objects and represents that three relationships may exist. For example, A and/or B may represent the following three cases: Only A exists, both A and B exist, and only B exists. In addition, the character “/” in this specification generally represents an “or” relationship between the associated objects.

It should be understood that although terms “first”, “second”, “third”, and the like may be used to describe XXX in the embodiments of the present invention, but the XXX is not limited to the terms. These terms are merely used to differentiate between the XXX. For example, without departing from the scope of the embodiments of the present invention, first XXX may also be referred to as second XXX, and similarly, the second XXX may also be referred to as the first XXX.

Depending on the context, for example, the word “if” used herein may be explained as “while”, “when”, “in response to determining that”, or “in response to detecting that”. Similarly, depending on the context, the phrase “if it is determined that” or “if it is detected that (a stated condition or event)” may be explained as “when determining that”, “in response to determining that”, “when detecting that (the stated condition or event)”, or “in response to detecting that (the stated condition or event)”.

It should be further noted that, the terms “include”, “contain”, or their any other variant is intended to cover a non-exclusive inclusion, so that a product or system that includes a list of elements not only includes those elements but also includes other elements that are not expressly listed, or further includes elements inherent to such product or system. An element preceded by “includes a . . . ” does not, without more constraints, preclude the existence of additional identical elements in the process, method, article, or device that includes the element.

An intra-city delivery scenario is used as an example. In most of existing logistics scheduling policies, scheduling is performed based on commercial areas, i.e., a logistics scheduling system groups the delivery orders received at a particular time according to the commercial area to which delivery orders belong to obtain multiple delivery orders corresponding to each commercial area. Further, for any commercial area, multiple delivery orders in the commercial area are grouped based on a pre-specified similarity threshold, to obtain one or more delivery order groups. Then, each obtained delivery order group is allocated to a delivery person belonging to the commercial area.

Currently, in grouping of multiple delivery orders, the multiple delivery orders need to be grouped based on comparison between a similarity threshold and similarity between the multiple delivery orders, and an existing similarity threshold is set based on human experience.

It is found through research that grouping delivery orders according to the similarity threshold set based on human experience has adverse impact on delivery efficiency and delivery capacity utilization.

Specifically, for any commercial area, delivery capacity pressure in the commercial area may differ significantly at different times. In one case, it is assumed that delivery capacity pressure in the commercial area is relatively high in one period of time, i.e., a delivery person in the commercial area is usually relatively busy, and there is a relatively large number of delivery orders. In this case, if a relatively large number of order groups are obtained after multiple newly received delivery orders belonging to the commercial area are grouped based on the pre-specified similarity threshold, a relatively large number of delivery persons would be required to handle these delivery order groups. As a result, more delivery capacities would be required. In addition, from the delivery efficiency perspective, since there are relatively large number of delivery persons to which the delivery order groups are allocated, and these delivery person are scattered, overall, the delivery persons need to travel longer distances and take a longer time to complete delivery of these delivery order groups, and overall delivery efficiency will be relatively low.

On the contrary, in another case, it is assumed that delivery capacity pressure in the commercial area is relatively low in that period of time, i.e., a delivery person in the commercial area is usually relatively free, and there is a relatively small number of delivery orders. In this case, if a relatively small number of order groups are obtained after multiple newly received delivery orders belonging to the commercial area are grouped based on the pre-specified similarity threshold, only a small number of delivery persons are required to handle these delivery order groups, i.e., these delivery order groups are delivered by only the small number of delivery persons. Consequently, delivery capacity utilization in the commercial area is low. In addition, the number of orders in each group varies from time to time, and the number of orders allocated to each delivery person varies too. If the delivery persons with large number of allocated orders cannot ensure a good on-time arrival rate, overall delivery efficiency of all the delivery orders would be relatively low.

Therefore, if the grouping result of delivery orders can adapt to the current delivery capacity pressure in a commercial area, relatively high delivery efficiency and delivery capacity utilization can be ensured. A similarity threshold can be used to determine the grouping result of multiple delivery orders. Therefore, setting a similarity threshold according to the current delivery capacity pressure in the commercial area can improve delivery efficiency and delivery capacity utilization.

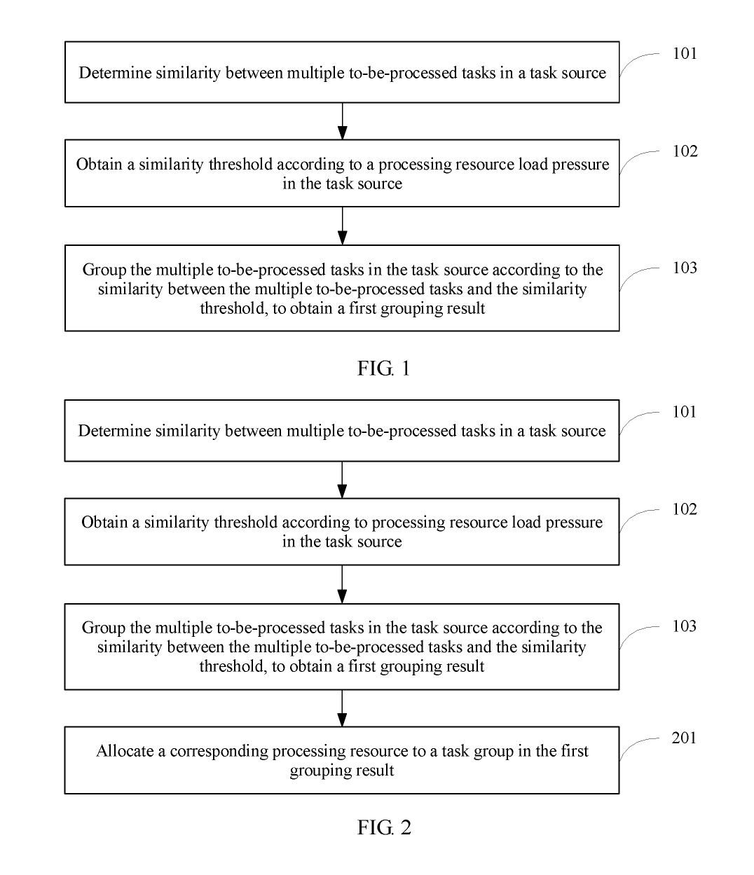

FIG. 1 is a flowchart of Embodiment 1 of a task grouping method according to an embodiment of the present invention, and the task grouping method provided in this embodiment may be performed by a task grouping apparatus. The task grouping apparatus may be implemented as software, or implemented as a combination of software and hardware. The task grouping apparatus may be integrated into a management device on a task scheduling platform side, for example, integrated into a server. As shown in FIG. 1, the method includes the following steps:

Step 101: Determine similarity between multiple to-be-processed tasks in a task source.

Step 102: Obtain a similarity threshold according to a processing resource load pressure in the task source.

Step 103: Group the multiple to-be-processed tasks in the task source according to the similarity between the multiple to-be-processed tasks and the similarity threshold, to obtain a first grouping result.

In this embodiment, the task source corresponds to multiple to-be-processed tasks and multiple processing resources. The processing resources are used for processing the tasks. The task source may be understood as a system that generates a task, or may be understood as a system that generates a task and also processes the task. Alternatively, the task source may be understood as the attributes of a task, i.e., the task is corresponding to which task source. Similarly, the processing resources used for processing the tasks also correspond to the task source, i.e., different task sources may correspond to different available processing resources.

A task processing policy in this embodiment is as follows: The multiple to-be-processed tasks corresponding to the task source are grouped into one or more task groups, and the task groups obtained by grouping are allocated to processing resources in a processing resource group corresponding to the task source for processing.

The task groups are obtained based on a result of comparing the similarity threshold with the similarity between the to-be-processed tasks.

Optionally, the task source may correspond to multiple to-be-processed tasks at a particular moment. Similarity between every two to-be-processed tasks may be calculated based on a preset similarity measurement parameter. When there are multiple similarity measurement parameters, the similarity between every two to-be-processed tasks may be determined by a weighted sum of similarity respectively corresponding to the multiple similarity measurement parameters. A weight corresponding to each similarity measurement parameter may be preset.

In this embodiment, a currently used similarity threshold is determined based on current processing resource load pressure corresponding to the task source instead of an original manner of presetting the similarity threshold.

In an example embodiment, the processing resource load pressure corresponding to the task source may be first determined in the following manner:

obtaining the number of uncompleted tasks in the task source and the number of processing resources in the task source; and determining the processing resource load pressure according to the number of uncompleted tasks and the number of processing resources.

A value of the processing resource load pressure is equal to the number of uncompleted tasks/the number of processing resources. The value may be considered as average processing resource load pressure corresponding to the task source. The uncompleted tasks may include the multiple to-be-processed tasks in the task source and an uncompleted task allocated to a processing resource corresponding to the task source.

The number of uncompleted tasks in the task source may be determined based on monitoring of the processing state of each task in the task source. That is, for any task, the task may be in multiple processing states such as “unallocated”, “under processing”, and “completed”. “Unallocated” is a state that the task has not been allocated to a processing resource, “under processing” means that the task has been added to a task group and is allocated to a processing resource and the processing resource is processing the task, and “completed” means that a corresponding processing resource has completed processing of the task. The multiple to-be-processed tasks corresponding to the task source in this embodiment may include an unallocated task, and the uncompleted task corresponding to the task source may include tasks other than a completed task.

Optionally, after the processing resource load pressure is obtained, the similarity threshold may be obtained based on a preset function relationship between the similarity threshold and the processing resource load pressure. The function relationship may be determined according to an actual scenario. However, in an actual application sense, the processing resource load pressure is inversely proportional to the similarity threshold. That is, higher processing resource load pressure requires a smaller similarity threshold, and on the contrary, lower processing resource load pressure requires a higher similarity threshold.

The following describes why the similarity threshold and the processing resource load pressure are set to the relationship.

Assuming that the current processing resource load pressure is relatively high, it indicates that the processing resources corresponding to the task source have relatively heavy overall load, and each processing resource may carry a relatively large number of task groups. In this case, if a relatively low similarity threshold is set, multiple to-be-processed tasks that are newly obtained currently are more likely to be grouped into a same task group. Therefore, a relatively small number of task groups are obtained, a relatively number of processing resources are required, and no more processing resources that already have relatively heavy load are occupied.

On the contrary, assuming that the current processing resource load pressure is relatively low, it indicates that the processing resources corresponding to the task source have relatively light overall load, and each processing resource may carry a relatively small number of task groups. In this case, if a relatively high similarity threshold is set, it is more difficult to group multiple to-be-processed tasks that are newly obtained currently into a same task group. Therefore, a relatively large number of task groups are obtained, and a relatively large number of required processing resources are required. Because the processing resources have relatively light load in this case, if the multiple to-be-processed tasks are grouped into more task groups, more processing resources participate in processing of these to-be-processed tasks. Therefore, the processing resources can be fully used, and processing of the tasks can be completed more quickly, thereby improving task processing efficiency.

Therefore, after the currently used similarity threshold is obtained according to the current processing resource load pressure in the task source, the multiple to-be-processed tasks are grouped based on the similarity threshold, to obtain a corresponding grouping result, i.e., the first grouping result. Grouping means that to-be-processed tasks with similarity greater than or equal to the similarity threshold are grouped into a same group. For example, if similarity between a task A and a task B is greater than or equal to the similarity threshold, and similarity between the task A and a task C is greater than or equal to the similarity threshold, the tasks A, B, and C are grouped into a same group. The first grouping result may include one or more task groups, and the number of to-be-processed tasks included in each task group is determined according to a similarity measurement result. Further, the task groups of the to-be-processed tasks may be processed based on the first grouping result.

In this embodiment, when multiple to-be-processed tasks in a task source need to be grouped, similarity between the multiple to-be-processed tasks is first calculated based on a similarity measurement parameter, then a corresponding similarity threshold in this case is obtained according to current processing resource load pressure in the task source, and afterwards, the multiple to-be-processed tasks are grouped according to a result of comparing the similarity threshold with the similarity between the multiple to-be-processed tasks to obtain a corresponding grouping result, so as to allocate a corresponding processing resource to each task group based on the grouping result for task processing. The similarity threshold used for obtaining task groups by grouping is obtained according to the current processing resource load pressure in the task source, i.e., the similarity threshold dynamically changes according to the processing resource load pressure. Therefore, a task grouping result can adapt to the processing resource load pressure, which helps improve processing resource utilization and task processing efficiency.

FIG. 2 is a flowchart of Embodiment 2 of a task grouping method according to an embodiment of the present invention. As shown in FIG. 2, based on the embodiment shown in FIG. 1, after step 103, the method may further include the following step:

Step 201: Allocate a corresponding processing resource to a task group in the first grouping result.

In this embodiment, the first grouping result includes one or more task groups. After the multiple to-be-processed tasks are grouped into the task groups based on the similarity threshold, because the similarity threshold is determined according to the processing resource load pressure in the task source, it may be considered that the first grouping result well adapts a current processing resource load status. Therefore, it is considered that the first grouping result is a better grouping result, and the to-be-processed tasks may be directly processed in groups based on the first grouping result, i.e., the corresponding resource is allocated to the task group in the first grouping result.

Optionally, there may be multiple task groups in the first grouping result. When processing resources are allocated to the task groups in the first grouping result, a corresponding processing resource may be allocated to each task group based on a degree of matching between the task group and the processing resource. That is, a degree of matching between any task group in the first grouping result and each of one or more processing resources corresponding to the task source is calculated, and a corresponding processing resource is allocated to the task group based on degrees of matching. The task group is processed by the allocated processing resource. Optionally, a processing resource that matches each task group in a highest degree is allocated to the task group.

Matching degree measurement parameters vary according to actual applicable application scenarios. In a subsequent embodiment, descriptions are provided with reference to an actual application scenario.

In this embodiment, the similarity threshold used for obtaining the task groups by grouping is determined based on the processing resource load pressure in the task source, and the processing resource load pressure has obvious impact on task processing efficiency and processing resource utilization. Therefore, grouping the multiple to-be-processed tasks based on the similarity threshold may be considered as a better grouping manner that helps ensure processing resource utilization and task processing efficiency.

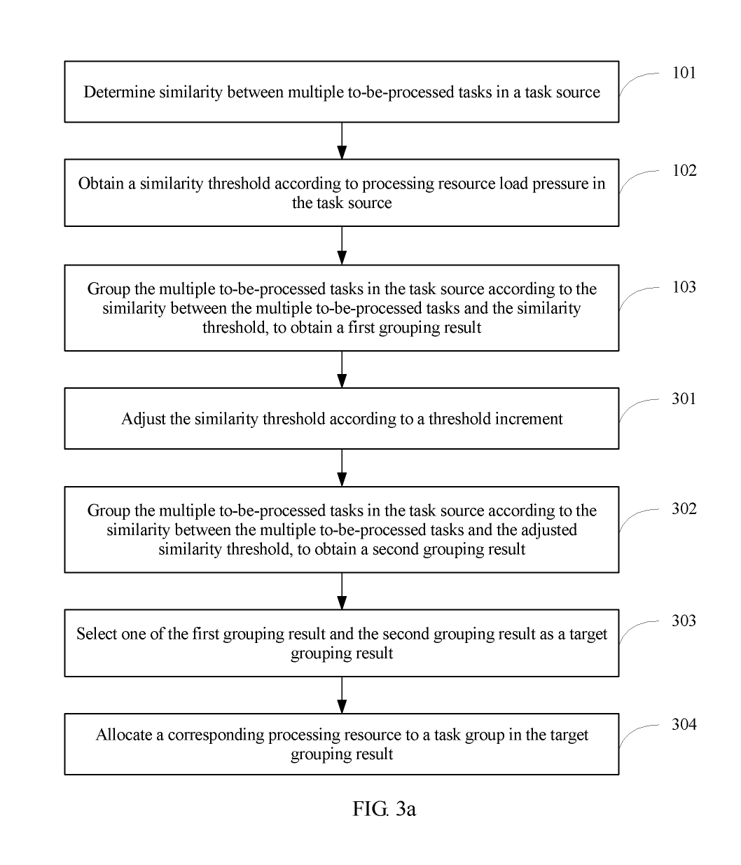

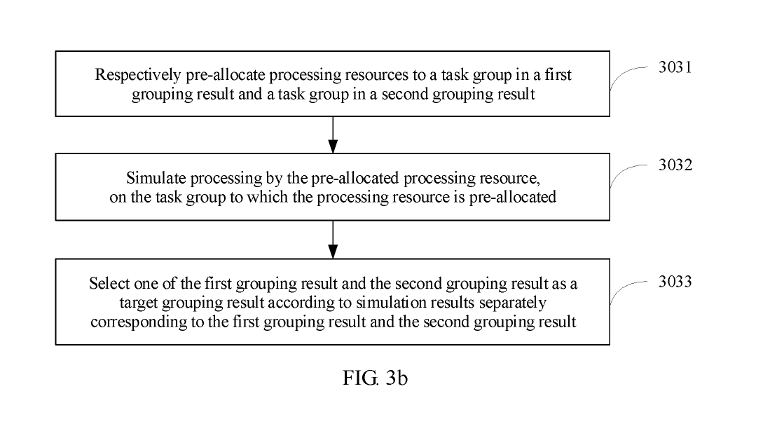

In the embodiment shown in FIG. 2, it is considered that the first grouping result obtained based on the similarity threshold is the best grouping result. However, in actual application, the first grouping result may be or may not be the best grouping result. A reason is that the processing resource load pressure represents average load pressure of a processing resource group corresponding to the task source, and there may be an imbalance phenomenon that some processing resources have low load pressure and some other processing resources have high load pressure. Therefore, in consideration of impact exerted by imbalance between the load pressure of the processing resources on optimality of a grouping result obtained by performing grouping based on the similarity threshold, an embodiment of the present invention proposes a solution in which the similarity threshold is adjusted according to an increment, the multiple to-be-processed tasks are grouped multiple times, and an optimal grouping result is selected from multiple grouping results. The solution is described with reference to an embodiment shown in FIG. 3a.

FIG. 3 is a flowchart of Embodiment 3 of a task grouping method according to an embodiment of the present invention. As shown in FIG. 3a, based on the embodiment shown in FIG. 1, the method may further include the following steps.

Step 301: Adjust the similarity threshold according to a threshold increment.

The threshold increment may be a preset fixed increment value, or may be an increment value obtained by attempts. In addition, the similarity threshold may be adjusted by adding/subtracting an integral multiple of the threshold increment, so that multiple adjusted similarity thresholds may be obtained. A number of adjusted similarity thresholds may be set.

For ease of description, in this embodiment, it is assumed that the similarity threshold determined based on the processing resource load pressure is A, and the threshold increment is represented by a. In this case, the adjusted similarity threshold may include A−a, A−2a, A+a, A+2a, and the like.

The above-mentioned obtaining the threshold increment by attempts means that a relatively small threshold increment a0 may be set initially, and the similarity threshold A is adjusted based on a0. Assuming that the adjusted similarity threshold is A+a0, and multiple to-be-processed tasks are grouped based on A+a0 in this case. If a grouping result is consistent with a grouping result obtained after performing grouping based on A, it indicates that a0 is not large enough to change the grouping result, and the threshold increment is adjusted to a larger value a1. Further, the multiple to-be-processed tasks are grouped again based on A+a1. If a grouping result in this case is inconsistent with the grouping result obtained after performing grouping based on A, it is determined that al is the threshold increment a in this embodiment. It may be determined that the grouping results are inconsistent provided that one of the task groups is different.

Step 302: Group the multiple to-be-processed tasks in the task source according to the similarity between the multiple to-be-processed tasks and the adjusted similarity threshold, to obtain a second grouping result.

Because there may be multiple adjusted similarity thresholds, multiple second grouping results may be correspondingly obtained. That is, one similarity threshold corresponds to one grouping result.

For any adjusted similarity threshold, based on a result of comparing the adjusted similarity threshold with the similarity between the multiple to-be-processed tasks, to-be-processed tasks between which similarity is greater than or equal to the adjusted similarity threshold are grouped into one task group, to obtain the second grouping result constituted by one or more task groups obtained by grouping.

Step 303: Select one of the first grouping result and the second grouping result as a target grouping result.

Step 304: Allocate a corresponding processing resource to a task group in the target grouping result.

In this embodiment, it is assumed that a total number of similarity thresholds and adjusted similarity thresholds is N, and N is an integer greater than or equal to 2. Correspondingly, there are N grouping results. The N grouping results are used as candidate grouping solutions, and a target grouping result needs to be selected from the N grouping results, so as to process the multiple to-be-processed tasks based on the target grouping result, thereby exerting positive impact on processing efficiency and processing resource utilization. Therefore, corresponding processing resources are respectively allocated to task groups in the target grouping result based on the target grouping result, to process the tasks.

Optionally, FIG. 3b is a flowchart of an implementation of step 303 in the embodiment shown in FIG. 3a. As shown in FIG. 3b, the target grouping result may be selected by using the following steps.

Step 3031: Respectively pre-allocate processing resources to a task group in the first grouping result and a task group in the second grouping result.

In this embodiment, the processing resources may be pre-allocated in parallel to all grouping results, i.e., for each grouping result, processing resources are respectively pre-allocated to task groups in the grouping result. Alternatively, grouping results may be considered as a whole, and task groups corresponding to all the grouping results constitute a group set. Each task group included in the group set is associated and marked with a grouping result corresponding to the task group, i.e., each task group is marked with a label, to mark the grouping result to which the task group belongs. Therefore, processing resources are respectively pre-allocated to the task groups in each group set.

This is called pre-allocation due to the following reasons. On the one hand, the allocation does not mean that a task group is actually allocated to a corresponding processing resource, but means that it is assumed that the task group is allocated to the corresponding processing resource. On the other hand, allocation bases for the pre-allocation are the same for different grouping results or all task groups, and allocation is performed based on a state that each processing resource in a processing resource group in a task source is currently in when the multiple to-be-processed tasks are received. That is, pre-allocating any task group in any grouping result to a processing resource exerts no impact on whether any other task group can be pre-allocated to the processing resource.

A processing resource may be pre-allocated to any task group in the following manner:

determining a degree of matching between the task group in the first grouping result and each of processing resources corresponding to the task source and a degree of matching between the task group in the second grouping result and each of processing resources corresponding to the task source; and respectively pre-allocating, from the processing resources in the task source, the processing resources to the task group in the first grouping result and the task group in the second grouping result according to the degrees of matching.

For any task group, it is assumed that the task source is corresponding to M processing resources. In this case, a degree of matching between the task group and each of the M processing resources is analyzed based on a matching degree measurement parameter, to pre-allocate a processing resource that matches the task group in a highest degree to the task group. The matching degree measurement parameter varies with different actual scenarios.

Step 3032: Simulate processing, by the pre-allocated processing resource, on the task group to which the processing resource is pre-allocated.

After a corresponding resource is pre-allocated to each task group, processing, by the processing resource, on the task group to which the processing resource is pre-allocated is simulated. The simulation means simulation of processing, by the processing resource according to a normal processing process, on the task group to which the processing resource is pre-allocated, but a processing parameter used in the processing process is assumed, for example, time for completing each task in the task group is assumed in advance.

It should be noted that, because the processing resources in the task source exist objectively, current states such as the load of the processing resources also exist objectively. The objective states are used to perform pre-allocation processing for a task group. However, because pre-allocation processing for task groups is independent of each other and does not affect each other, it is very likely that a processing resource is pre-allocated to multiple task groups. Thus, in the simulation process, it may be considered that the processing resource independently processes the multiple task groups, and processing for the multiple task groups does not affect each other.

Step 3033: Select one of the first grouping result and the second grouping result as the target grouping result according to simulation results respectively corresponding to the first grouping result and the second grouping result.

In this embodiment, in the simulation process, processing, by each processing resource, on a task in each task group to which the processing resource is pre-allocated is simulated, and the simulation result corresponding to a task may be output after simulation of processing for the task is completed. A task group has an identifier of a grouping result to which the task group belongs, and similarly, the task may be marked with an identifier of a grouping result to which the task belongs and an identifier of a group to which the task belongs. A simulation result corresponding to each task is usually presented as a measurement result of an indicator, such as completion time.

Therefore, after simulation processing for tasks in all task groups is completed, the simulation result of each task in each task group is obtained. Because each task group is corresponding to a grouping result, the simulation result of each grouping result may be obtained by collecting statistics about simulation results of tasks in each task group. The simulation result of each grouping result is usually presented as an average measurement result of multiple to-be-processed tasks in terms of a specific indicator in the grouping manner.

Therefore, based on simulation results respectively corresponding to all the grouping results, a grouping result with a best simulation result may be selected from the simulation results as the target grouping result, so as to actually group the multiple to-be-processed tasks in a grouping manner of the target grouping result, to correspondingly allocate a processing resource to each task group obtained by grouping.

It may be understood that, corresponding processing resources have been pre-allocated to the task groups in the target grouping result in the pre-allocation processing process. Therefore, when it is determined that the target grouping result is used as a grouping basis for actual grouping, a pre-allocation solution may be directly used, i.e., the task groups obtained based on the target grouping result are actually allocated to the processing resources pre-allocated to the task groups.

In this embodiment, when multiple to-be-processed tasks are received, a similarity threshold used for obtaining task groups by grouping is first determined based on a processing resource load pressure in a task source, so as to ensure, to an extent, that the result of obtaining the task groups by grouping based on the similarity threshold can adapt to the current processing resource load level. Then the similarity threshold is adjusted based on a threshold increment, to obtain multiple adjusted similarity thresholds, and the multiple to-be-processed tasks are grouped again based on each adjusted similarity threshold. Therefore, an optimal grouping result is selected from multiple grouping results according to simulation of the multiple grouping results and based on the simulation result, and is used as an actually used grouping solution. This is helpful in improving task processing efficiency and overall processing resource utilization.

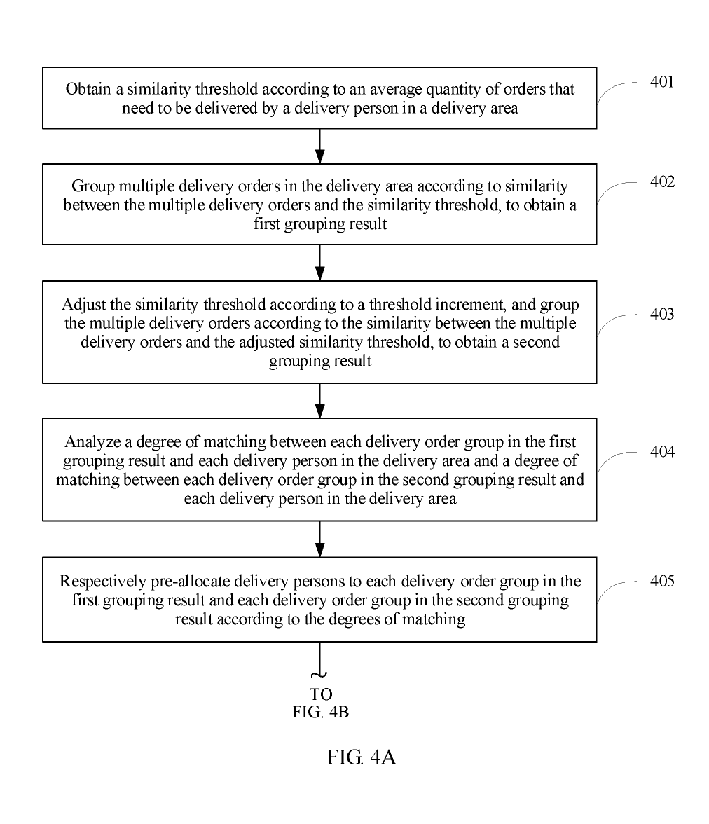

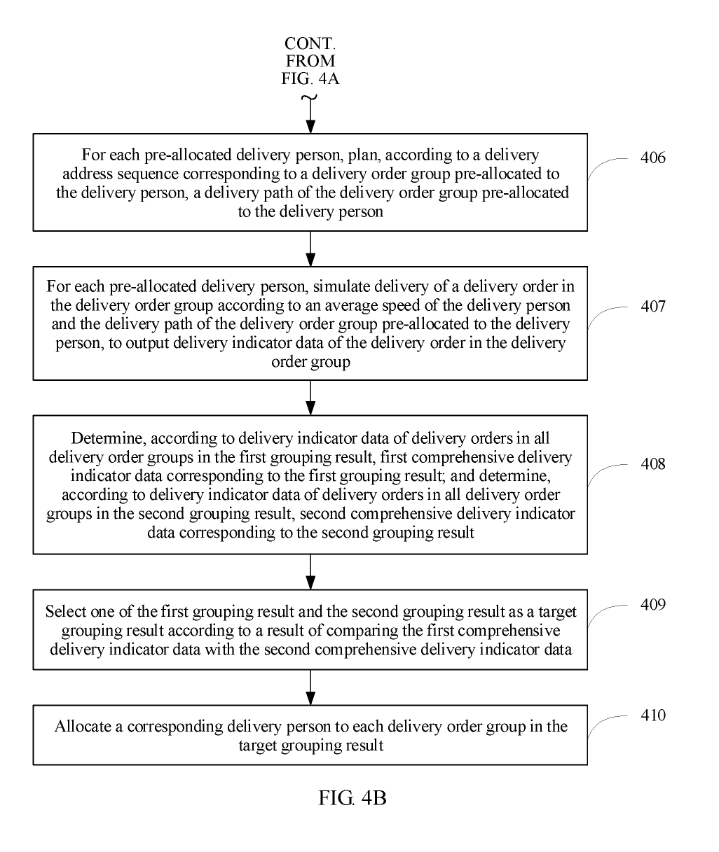

A delivery scenario is used as an example below. With reference to an embodiment shown in FIG. 4A and FIG. 4B, a process in which when multiple delivery orders in a delivery area are received, the multiple delivery orders are grouped and a corresponding delivery person is allocated to each delivery order group is described.

FIG. 4A and FIG. 4B are a flowchart of Embodiment 4 of a task grouping method according to an embodiment of the present invention. As shown in FIG. 4A and FIG. 4B, the method includes the following steps:

Step 401: Obtain a similarity threshold according to an average number of orders that need to be delivered by a delivery person in a delivery area.

Step 402: Group multiple delivery orders in the delivery area according to similarity between the multiple delivery orders and the similarity threshold, to obtain a first grouping result.

A takeout delivery scenario is used as an example in this embodiment. It is assumed that multiple delivery orders are received currently, and the multiple delivery orders are delivery orders corresponding to a same delivery area, i.e., pickup addresses of the multiple delivery orders are in a same delivery area.

First, similarity between every two delivery orders may be calculated based on a similarity measurement parameter. For example, the similarity measurement parameter includes one or more of a distance between pickup addresses, a distance between receiver addresses, or expected arrival time. In addition, the similarity measurement parameters may have a same weight or different weights.

Then, to group the multiple delivery orders based on the calculated similarity between every two delivery orders, a currently used similarity threshold may be obtained. The similarity threshold may be determined according to an average number of orders that need to be delivered by a delivery person in the delivery area to which the multiple delivery orders belong, i.e., determined according to delivery capacity pressure in the delivery area.

The average number of orders that need to be delivered by the delivery person in the delivery area, i.e., the delivery capacity pressure is equal to the number of uncompleted delivery orders in the delivery area divided by the number of delivery persons in the delivery area. The number of delivery persons is the number of on-the-job delivery persons, or is referred to as the number of online delivery persons.

For delivery of any delivery order, a delivery person usually needs to first go to a pickup address to get items that need to be delivered, and then deliver the items to a receiver address. Therefore, in this embodiment, the number of uncompleted delivery orders is constituted by the number of unallocated delivery orders, the number of to-be-picked-up delivery orders, and the number of to-be-delivered delivery orders. An unallocated delivery order is a delivery order that has not been allocated to any delivery person. A to-be-picked-up delivery order means that the delivery order has been allocated to a delivery person, and the delivery person has accepted the order and is going to a pickup address to get items. A to-be-delivered delivery order means that a delivery person has got items and is going to a receiver address to deliver the items. The unallocated state, the to-be-picked-up state, and the to-be-delivered state of the delivery order may be obtained based on reporting of the delivery person. That is, each time the delivery person triggers an operation that changes a delivery status of the delivery order, the delivery person actively reports a current state of the delivery order.

In addition, optionally, when statistics about the number of uncompleted delivery orders in the delivery area are collected, different weights may be set for the delivery orders in the three delivery states. For example, a weight of the unallocated delivery order and a weight of the to-be-picked-up delivery order are set to 1, and a weight of the to-be-delivered delivery order is set to 0.5 because the to-be-delivered delivery order is to release an occupied delivery capacity, i.e., a delivery person.

After the delivery capacity pressure in the delivery area is calculated based on the obtained number of uncompleted delivery orders in the delivery area and the obtained number of delivery persons in the delivery area, the currently used similarity threshold may be determined based on a preset function relationship between the delivery capacity pressure and the similarity threshold, so as to group the multiple delivery orders into multiple delivery order groups based on the similarity threshold, to obtain the first grouping result.

Generally, higher delivery capacity pressure requires a smaller similarity threshold. Therefore, the multiple delivery orders are more likely to be grouped into a same group, and a smaller number of delivery order groups are obtained. In this case, fewer delivery persons are occupied because one delivery order group is allocated to one delivery person. Because there are a relatively small number of delivery order groups, it means that there may be a relatively large number of orders in one delivery order group. In addition, because these orders are grouped into a same group, it means that these orders may be in centralized distribution in a sub-area, and are delivered by a same delivery person. Therefore, a problem that a large delivery capacity is required because more delivery persons need to travel a longer distance before completing delivery can be avoided, thereby reducing a delivery capacity.

On the contrary, lower delivery capacity pressure requires a larger similarity threshold. Therefore, it is more difficult to group the multiple delivery orders into the same group, and a larger number of delivery order groups are obtained. In this case, each delivery person has relatively low pressure, multiple delivery order groups mean that more delivery persons are required, and there are a relatively small number of orders in each delivery order group. Therefore, a corresponding delivery person may quickly complete delivery of corresponding delivery orders in each delivery order group, thereby improving order delivery efficiency.

Step 403: Adjust the similarity threshold according to a threshold increment, and group the multiple delivery orders according to the similarity between the multiple delivery orders and the adjusted similarity threshold, to obtain a second grouping result.

In this embodiment, to avoid a problem that the first grouping result obtained by grouping only according to the similarity threshold is not optimal, the similarity threshold is adjusted in an incremental adjustment manner based on the similarity threshold. Therefore, for each adjusted similarity threshold, the multiple delivery orders are grouped again, to obtain the corresponding second grouping result. The number of second grouping results is equal to the number of adjusted similarity thresholds.

Step 404: Determine a degree of matching between each delivery order group in the first grouping result and each delivery person in the delivery area and a degree of matching between each delivery order group in the second grouping result and each delivery person in the delivery area.

Step 405: Respectively pre-allocate delivery persons to each delivery order group in the first grouping result and each delivery order group in the second grouping result according to the degrees of matching.

In this embodiment, it is assumed that the first grouping result and second grouping results constitute N grouping results in total. To select an optimal grouping result from the N grouping results, i.e., a grouping result that can better ensure delivery efficiency of the delivery orders and delivery capacity utilization of the delivery person, delivery processes of delivery performed based on all the grouping results are simulated, to select, from all the grouping results, a grouping result with optimal delivery indicator data as the target grouping result based on delivery indicator data corresponding to all the grouping results.

In a simulation process, a corresponding delivery person may be first pre-allocated to each delivery order group included in each grouping result.

For example, it is assumed that any grouping result Ni in the N grouping results includes a delivery order group 1 and a delivery order group 2. A degree of matching between the delivery order group 1 and each delivery person in the delivery area and a degree of matching between the delivery order group 2 and each delivery person in the delivery area are respectively calculated, and delivery persons who match the delivery order group 1 and the delivery order group 2 in a highest degree are respectively pre-allocated to the delivery order group 1 and the delivery order group 2 based on the degrees of matching.

For example, the degrees of matching may be determined based on multiple measurement parameters such as the distance and the number of delivery orders owned by a delivery person.

For example, the degree of matching is measured based on distance. For the delivery order group 1, it is assumed that the delivery order group includes a delivery order a and a delivery order b, a pickup address and a receiver address corresponding to the delivery order a are respectively a1 and a2, and a pickup address and a receiver address corresponding to the delivery order b are respectively b1 and b2. In addition, it is assumed that the delivery addresses corresponding to the delivery order a and the delivery order b have been sorted based on a specific address sorting rule, and a sorting result is the following address sequence: a1, b1, a2, and b2. In this case, a delivery person closest to al may be determined based on detection of a current location of each delivery person in the delivery area by calculating a distance between the current location of each delivery person and the first address a1 in the address sequence. When the distance is used as a matching degree measurement parameter, it may be directly determined that the delivery person closest to a1 is a pre-allocated delivery person corresponding to the delivery order group 1.

It should be noted that, with reference to the embodiment shown in FIG. 3a, for a pre-allocation process of the N grouping results, the N grouping results may be considered as mutually independent grouping results, and pre-allocation processing for all the grouping results is performed in parallel. Alternatively, the N grouping results may be considered as a whole, and pre-allocation processing is performed on all delivery order groups corresponding to the N grouping results.

Step 406: For each pre-allocated delivery person, plan, according to a delivery address sequence corresponding to a delivery order group pre-allocated to the delivery person, a delivery path of the delivery order group pre-allocated to the delivery person.

Step 407: For each pre-allocated delivery person, simulate delivery of a delivery order in the delivery order group according to an average speed of the delivery person and the delivery path of the delivery order group pre-allocated to the delivery person, to output delivery indicator data of the delivery order in the delivery order group.

Step 408: Determine, according to delivery indicator data of delivery orders in all delivery order groups in the first grouping result, first comprehensive delivery indicator data corresponding to the first grouping result; and determine, according to delivery indicator data of delivery orders in all delivery order groups in the second grouping result, second comprehensive delivery indicator data corresponding to the second grouping result.

Step 409: Select one of the first grouping result and the second grouping result as a target grouping result according to a result of comparing the first comprehensive delivery indicator data with the second comprehensive delivery indicator data.

Step 410: Allocate a corresponding delivery person to each delivery order group in the target grouping result.

In this embodiment, after a corresponding delivery person is pre-allocated to each delivery order group in any grouping result, a process of delivering, by each delivery person, a delivery order group pre-allocated to the delivery person is simulated. The delivery indicator data includes a delivery distance, delivery duration, arrival time, and the like.

The foregoing example is used for description. It is assumed that the delivery order group 1 is pre-allocated to a delivery person s. In a process of simulating delivery of the delivery order group 1 by the delivery person s, a delivery path of the delivery order group 1 is first planned based on the delivery address sequence a1, b1, a2, and b2 corresponding to the delivery order group 1. In this case, an electronic map service interface may be invoked, and a delivery path may be planned with the help of an electronic map navigation function, to successively connect the foregoing a1, b1, a2, b2 in series. Then, it is simulated that the delivery person moves along the delivery path at a preset average speed to complete delivery of the delivery orders in the delivery order group 1, so that delivery indicator data corresponding to the delivery order a and the delivery order b in the delivery order group 1 is output after the delivery path is completed. In the simulation process, a delivery process may be simulated with reference to a preset stay time at each delivery address in addition to the preset average speed.

The delivery order group 1 includes the delivery order a and the delivery order b. The delivery order a is used as an example. For example, delivery indicator data corresponding to the delivery order a is the delivery distance between the pickup address a1 and the receiver address a2 that are corresponding to the delivery order a, delivery duration, and arrival time. Similarly, the delivery indicator data can also be obtained for the delivery order b. Likewise, delivery indicator data of each delivery order in the delivery order group 2 in the grouping result Ni can also be obtained. Therefore, delivery indicator data respectively corresponding to all delivery orders in the grouping result Ni can be obtained, and comprehensive delivery indicator data corresponding to the grouping result Ni can be obtained by collecting statistics about the delivery indicator data

When output delivery indicator data corresponding to each delivery order includes indicators such as delivery distance, delivery duration, and arrival time, the comprehensive delivery indicator data corresponding to the grouping result Ni may include, for example, average delivery duration corresponding to all the delivery orders, average delivery duration corresponding to K delivery orders that have longest delivery duration in all the delivery orders, average delivery distance corresponding to all the delivery orders, average on-time arrival rate corresponding to all the delivery orders, average pickup distance corresponding to all the delivery orders, and average delivery distance corresponding to all the delivery orders. The on-time arrival rate needs to be determined according to simulated arrival time and expected arrival time of each delivery order, and the expected arrival time objectively exists as an attribute of the delivery order when the delivery order is received.

In conclusion, the foregoing delivery simulation processing is performed for each of the N grouping results to obtain comprehensive delivery indicator data corresponding to each grouping result. Based on quality of comprehensive delivery indicator data respectively corresponding to the N grouping results, a grouping result with optimal comprehensive delivery indicator data is selected from the N grouping results as the target grouping result.

When the comprehensive delivery indicator data includes multiple delivery indicators, a corresponding comprehensive score may be obtained by weighted summation according to preset weights of the multiple delivery indicators, to select a grouping result with a highest score as the target grouping result according to comprehensive scores respectively corresponding to the N grouping results.

After the target grouping result is selected, actual delivery processing may be performed by directly using the target grouping result and a delivery person pre-allocated to the target grouping result, so as to ensure delivery capacity utilization of the delivery person and delivery efficiency of the delivery order.

For more intuitive understanding of an idea of this embodiment, an implementation process of this embodiment is intuitively described with reference to

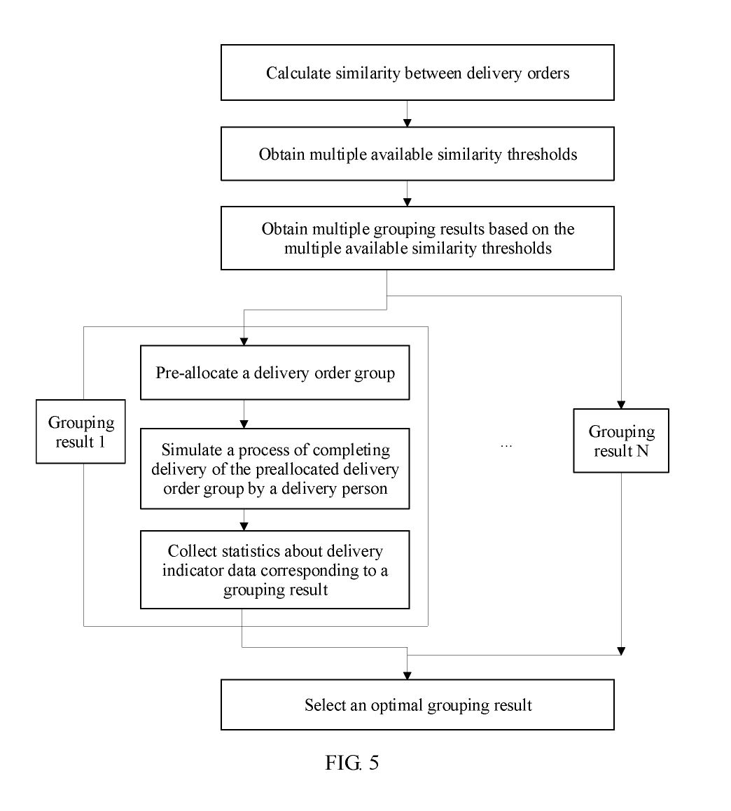

FIG. 5 by using a process of performing pre-allocation and simulation on group results in parallel as an example. In the figure, multiple available similarity thresholds are the similarity thresholds and the adjusted similarity thresholds in the foregoing embodiments.

The following describes in detail a task grouping apparatus in one or more embodiments of the present invention. These task grouping apparatuses may be implemented in an infrastructure of a server or in a server-side architecture in which a client interacts with a server. Persons skilled in the art may understand that all these task grouping apparatuses may be constituted by configuring, according to the steps in this solution, hardware components sold in the market.

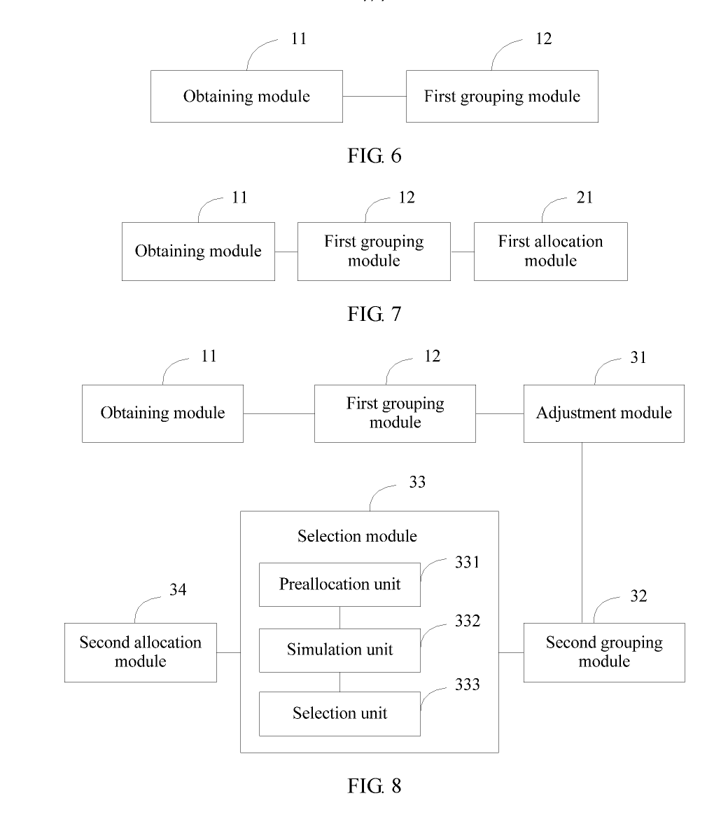

FIG. 6 is a schematic structural diagram of Embodiment 1 of a task grouping apparatus according to an embodiment of the present invention. As shown in FIG. 6, the task grouping apparatus includes an obtaining module 11 and a first grouping module 12.

The obtaining module 11 is configured to obtain a similarity threshold according to a processing resource load pressure in a task source.

The first grouping module 12 is configured to group multiple to-be-processed tasks in the task source according to similarity between the multiple to-be-processed tasks and the similarity threshold, to obtain a first grouping result.

The obtaining module 11 is configured to:

obtain the number of uncompleted tasks in the task source and the number of processing resources in the task source; and determine the similarity threshold according to the number of uncompleted tasks and the number of processing resources.

The apparatus shown in FIG. 6 may perform the method in the embodiment shown in FIG. 1. For a part that is not described in detail in this embodiment, refer to related descriptions in the embodiment shown in FIG. 1. For an execution process and a technical effect of this technical solution, refer to descriptions in the embodiment shown in FIG. 1. Details are not described herein again.

FIG. 7 is a schematic structural diagram of Embodiment 2 of a task grouping apparatus according to an embodiment of the present invention. As shown in FIG. 7, based on the embodiment shown in FIG. 6, the apparatus further includes a first allocation module 21.

The first allocation module 21 is configured to allocate a corresponding processing resource to a task group in the first grouping result.

The apparatus shown in FIG. 7 may perform the method in the embodiment shown in FIG. 2. For a part that is not described in detail in this embodiment, refer to related descriptions in the embodiment shown in FIG. 2. For an execution process and a technical effect of this technical solution, refer to descriptions in the embodiment shown in FIG. 2. Details are not described herein again.

FIG. 8 is a schematic structural diagram of Embodiment 3 of a task grouping apparatus according to an embodiment of the present invention. As shown in FIG. 8, based on the embodiment shown in FIG. 6, the apparatus further includes an adjustment module 31, a second grouping module 32, a selection module 33, and a second allocation module 34.

The adjustment module 31 is configured to adjust the similarity threshold according to a threshold increment.

The second grouping module 32 is configured to group the multiple to-be-processed tasks according to the similarity and the adjusted similarity threshold, to obtain a second grouping result.

The selection module 33 is configured to select one of the first grouping result and the second grouping result as a target grouping result.

The second allocation module 34 is configured to allocate a corresponding processing resource to a task group in the target grouping result.

Optionally, the selection module 33 includes a pre-allocation unit 331, a simulation unit 332, and a selection unit 333.

The pre-allocation unit 331 is configured to respectively pre-allocate processing resources to a task group in the first grouping result and a task group in the second grouping result.

The simulation unit 332 is configured to simulate processing by the processing resource on the task group to which the processing resource is pre-allocated.

The selection unit 333 is configured to select one of the first grouping result and the second grouping result as the target grouping result according to simulation results respectively corresponding to the first grouping result and the second grouping result.

Optionally, the pre-allocation unit 331 includes:

a first determining submodule, configured to determine a degree of matching between the task group in the first grouping result and each of processing resources in the task source and a degree of matching between the task group in the second grouping result and each of processing resources in the task source; and
a pre-allocation submodule, configured to respectively pre-allocate, from the processing resources in the task source, the processing resources to the task group in the first grouping result and the task group in the second grouping result according to the degrees of matching.

Optionally, in an actual scenario, the task source is a delivery area, the multiple to-be-processed tasks are multiple delivery orders, the task group is a delivery order group, the processing resource is a delivery person in the delivery area, and the processing resource load pressure is an average number of orders that need to be delivered by the delivery person.

Therefore, optionally, the simulation unit 332 includes:
a planning submodule, configured to plan, according to a delivery address sequence corresponding to a delivery order group to which the processing resource is pre-allocated, a delivery path of a delivery person corresponding to the delivery order group; and
a simulation submodule, configured to: simulate delivery of a delivery order in the delivery order group according to an average speed of the delivery person and the delivery path, and output delivery indicator data of the delivery order in the delivery order group.

Optionally, the selection unit 333 includes:
a second determining submodule, configured to determine, according to delivery indicator data of delivery orders in all delivery order groups in the first grouping result, first comprehensive delivery indicator data corresponding to the first grouping result;
a third determining submodule, configured to determine, according to delivery indicator data of delivery orders in all delivery order groups in the second grouping result, second comprehensive delivery indicator data corresponding to the second grouping result; and
a selection submodule, configured to select one of the first grouping result and the second grouping result as the target grouping result according to a result of comparing the first comprehensive delivery indicator data with the second comprehensive delivery indicator data.

An embodiment of the present invention discloses a computer storage medium. The computer storage medium stores a computer program, and when the computer program is executed, steps in the task grouping method related to FIG. 1 to FIG. 5 are implemented.

An embodiment of the present invention further discloses an electronic device, and the electronic device includes a memory and a processor.

The memory is configured to store one or more computer instructions, and the one or more computer instructions are executed by the processor to implement steps in the task grouping method related to FIG. 1 to FIG. 5.

The apparatus shown in FIG. 8 may perform the methods in the embodiments shown in FIG. 3a, FIG. 3b, and FIG. 4A and FIG. 4B. For a part that is not described in detail in this embodiment, refer to related descriptions in the embodiments shown in FIG. 3a, FIG. 3b, and FIG. 4A and FIG. 4B. For an execution process and a technical effect of this technical solution, refer to descriptions in the embodiments shown in FIG. 3a, FIG. 3b, and FIG. 4A and FIG. 4B. Details are not described herein again.

The apparatus embodiments described above are merely examples. The units described as separate parts may or may not be physically separate, and parts displayed as units may or may not be physical units, may be located in one position, or may be distributed on multiple network units. Some or all of the modules may be selected according to actual needs to achieve the objectives of the solutions of the embodiments. Persons of ordinary skill in the art may understand and implement the embodiments of the present invention without creative efforts.

Based on the foregoing descriptions of the implementations, persons of ordinary skill in the art may clearly understand that each implementation may be implemented by software in addition to a necessary general hardware platform or may be directly implemented by hardware. Based on such understanding, the foregoing technical solutions essentially or the part contributing to the prior art may be implemented as a product. The computer product may be stored in a computer readable storage medium, such as a ROM/RAM, a hard disk, or an optical disc, and include several instructions for instructing a computer apparatus (which may be a personal computer, a server, a network apparatus, or the like) to perform the methods described in the embodiments or some parts of the embodiments.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. (canceled)

2. (canceled)

3. (canceled)

4. A task grouping method, comprising: obtaining a similarity threshold according to a processing resource load pressure in a task source;
grouping multiple to-be-processed tasks in the task source according to similarity between the multiple to-be-processed tasks and the similarity threshold, to obtain a first grouping result;
adjusting the similarity threshold according to a threshold increment; and
grouping the multiple to-be-processed tasks according to the similarity and the adjusted similarity threshold, to obtain a second grouping result.

5. The method according to claim 4, wherein the method further comprises:
selecting one of the first grouping result and the second grouping result as a target grouping result; and
allocating a corresponding processing resource to a task group in the target grouping result.

6. The method according to claim 5, wherein selecting one of the first grouping result and the second grouping result as a target grouping result comprises:
respectively pre-allocating processing resources to a task group in the first grouping result and a task group in the second grouping result;
simulating processing by the processing resource on the task group to which the processing
selecting one of the first grouping result and the second grouping result as the target grouping result according to simulation results respectively corresponding to the first grouping result and the second grouping result.

7. The method according to claim 6, wherein respectively pre-allocating processing resources to a task group in the first grouping result and a task group in the second grouping result comprises:
determining a degree of matching between the task group in the first grouping result and each of processing resources in the task source and a degree of matching between the task group in the second grouping result and each of processing resources in the task source; and
respectively pre-allocating, from the processing resources in the task source, the processing resources to the task group in the first grouping result and the task group in the second grouping result according to the degrees of matching.

8. The method according to claim 6 or 7, wherein the task source is a delivery area, the multiple to-be-processed tasks are multiple delivery orders, the task group is a delivery order group, the processing resource is a delivery person in the delivery area, and the processing resource load pressure is an average number of orders that need to be delivered by the delivery person.

9. The method according to claim 8, wherein simulating processing, by the processing resource, on the task group to which the processing resource is pre-allocated comprises:
planning, according to a delivery address sequence corresponding to a delivery order group to which the processing resource is pre-allocated, a delivery path of a delivery person corresponding to the delivery order group; and
simulating, according to an average speed of the delivery person and the delivery path, delivery of a delivery order in the delivery order group, and outputting delivery indicator data of the delivery order in the delivery order group.

10. The method according to claim 9, wherein selecting one of the first grouping result and the second grouping result as the target grouping result according to simulation results respectively corresponding to the first grouping result and the second grouping result comprises:
determining, according to delivery indicator data of delivery orders in all delivery order groups in the first grouping result, first comprehensive delivery indicator data corresponding to the first grouping result;
determining, according to delivery indicator data of delivery orders in all delivery order groups in the second grouping result, second comprehensive delivery indicator data corresponding to the second grouping result; and
selecting one of the first grouping result and the second grouping result as the target grouping result according to a result of comparing the first comprehensive delivery indicator data with the second comprehensive delivery indicator data.

11. (canceled)

12. (canceled)

13. (canceled)

14. A task grouping apparatus, comprising:
an obtaining module, configured to obtain a similarity threshold according to a processing resource load pressure in a task source;
a first grouping module, configured to group multiple to-be-processed tasks in the task source according to similarity between the multiple to-be-processed tasks and the similarity threshold, to obtain a first grouping result
an adjustment module, configured to adjust the similarity threshold according to a threshold increment; and
a second grouping module, configured to group the multiple to-be-processed tasks according to the similarity and the adjusted similarity threshold, to obtain a second grouping result.

15. The apparatus according to claim 14, further comprising:
a selection module, configured to select one of the first grouping result and the second grouping result as a target grouping result; and
a second allocation module, configured to allocate a corresponding processing resource to a task group in the target grouping result.

16. The apparatus according to claim 15, wherein the selection module comprises:
a pre-allocation unit, configured to respectively pre-allocate processing resources to a task group in the first grouping result and a task group in the second grouping result;
a simulation unit, configured to simulate processing by the processing resource on the task group to which the processing resource is pre-allocated; and
a selection unit, configured to select one of the first grouping result and the second grouping result as the target grouping result according to simulation results respectively corresponding to the first grouping result and the second grouping result.

17. The apparatus according to claim 16, wherein the pre-allocation unit comprises:
a first determining submodule, configured to determine a degree of matching between the task group in the first grouping result and each of processing resources in the task source and a degree of matching between the task group in the second grouping result and each of processing resources in the task source; and
a pre-allocation submodule, configured to respectively pre-allocate, from the processing resources in the task source, the processing resources to the task group in the first grouping result and the task group in the second grouping result according to the degrees of matching.

18. (Presented Amended) The apparatus according to claim 16, wherein the task source is a delivery area, the multiple to-be-processed tasks are multiple delivery orders, the task group is a delivery order group, the processing resource is a delivery person in the delivery area, and the processing resource load pressure is an average number of orders that need to be delivered by the delivery person.

19. The apparatus according to claim 18, wherein the simulation unit comprises:
a planning submodule, configured to plan, according to a delivery address sequence corresponding to a delivery order group to which the processing resource is pre-allocated, a delivery path of a delivery person corresponding to the delivery order group; and
a simulation submodule, configured to: simulate, according to an average speed of the delivery person and the delivery path, delivery of a delivery order in the delivery order group, and output delivery indicator data of the delivery order in the delivery order group.

20. The apparatus according to claim 19, wherein the selection unit comprises:
a second determining submodule, configured to determine, according to delivery indicator data of delivery orders in all delivery order groups in the first grouping result, first comprehensive delivery indicator data corresponding to the first grouping result;
a third determining submodule, configured to determine, according to delivery indicator data of delivery orders in all delivery order groups in the second grouping result, second comprehensive delivery indicator data corresponding to the second grouping result; and
a selection submodule, configured to select one of the first grouping result and the second grouping result as the target grouping result according to a result of comparing the first comprehensive delivery indicator data with the second comprehensive delivery indicator data.

21. (canceled)

22. (canceled)
